(19) United States
(12) Patent Application Publication
(10) Pub. No.: US 2026/0314572 A1
(43) Pub. Date: Oct. 15, 2026

(54) A METHOD FOR ESTIMATING A WEIGHT OF A FISH

(71) Applicant: FISKHER AS, Lillesand (NO)

(72) Inventor: Trond SVANDAL, Vennesla (NO)

(21) Appl. No.: 19/483,685

(22) PCT Filed: May 15, 2024
(86) PCT No.: PCT/NO2024/050114

§ 371 Date: Nov. 12, 2025

(30) Foreign Application Priority Data
May 16, 2023 (NO) 20230578

(51) Int. Cl. A01K 61/95; G01B 11/02; G01G 9/00; G06Q 50/02; G06T 7/60; G06V 10/25; G06V 10/34; G06V 40/10

(52) U.S. Cl. CPC A01K 61/95; G01B 11/022; G01G 9/005; G06Q 50/02; G06T 7/60; G06V 10/25; G06V 10/34; G06V 40/103

(57) ABSTRACT

A method for estimating a weight of a fish by first taking a picture of said fish using a camera and send said picture to at least one AI model, wherein said picture is classified with regard to what species of fish has been caught, and then segment said picture by setting all pixels containing fish to a first value and remaining pixels are set to a second value, and send said segmented picture to an algorithm to find a centre line of said fish, and save all pixels that are on a calculated centre line, and map said pixels on said calculated centre line to “Real World” coordinates (x, y, z) and then augmented reality (AR) points (x, y, z) are placed along said calculated centre line of the fish and to be added up (integrate) all points along said calculated centre line and estimate a length of said fish and to use empirical length and weight values for said species to estimate said weight of said fish based on said estimated length and species of said fish.

### TECHNICAL FIELD

The present invention relates to a method for estimating a weight of a fish.

### BACKGROUND TO THE INVENTION

There is no method for analysing a fish from a picture taken by a mobile phone or the like so that one can register what type it is, weight length and where it was caught and at what time.

The invention as described in the application solves the problem mentioned above by its claims.

### SUMMARY OF THE INVENTION

The invention provides a method for estimating a weight of a fish, said method comprising the steps of;
take a picture of said fish using a camera,
send said picture to at least one AI model, wherein said picture is classified with regard to what species of fish has been caught,
segment said picture by setting all pixels containing fish to a first value and remaining pixles are set to a second value,
send said segmented picture to an algorithm to find a centre line of said fish, and save all pixels that are on a calculated centre line,
map said pixels on said calculated centre line to “Real World” coordinates (x, y, z),
augmented reality (AR) points (x, y, z) are then placed along said calculated centre line of the fish
add up (integrate) all points along said calculated centre line and estimate a length of said fish,
use empirical length and weight values for said species to estimate said weight of said fish based on said estimated length and said species of said fish.

Further embodiments are defined in the attached dependent claims.

### BRIEF DESCRIPTION OF THE FIGURES

FIG. 1 shows a procedure for segmenting a picture of a fish.

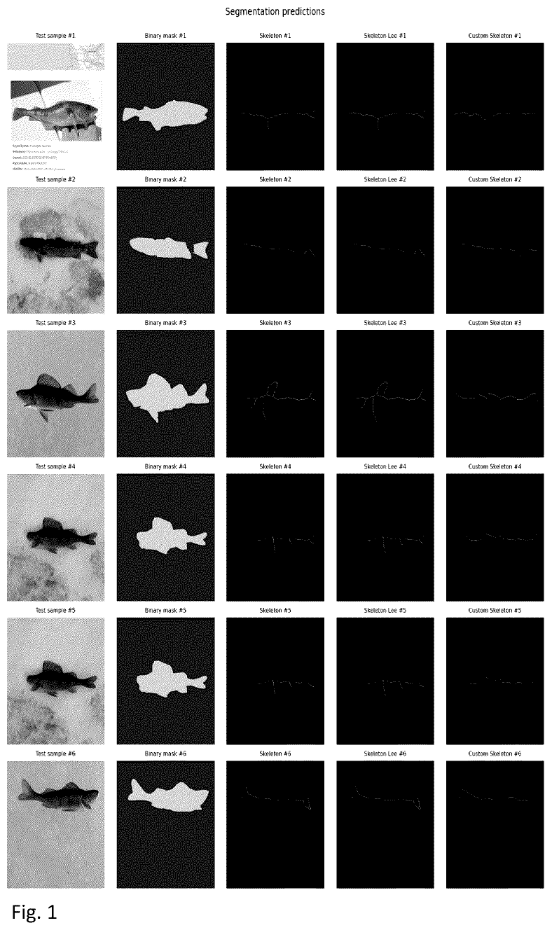

### DETAILED DESCRIPTION

In an embodiment of the invention it comprises the following steps:
Task flow on mobile phone.
1. User takes a picture of a fish with a mobile phone. The fish must be positioned so that said fish fills up as many pixels as possible in said picture (better result the more pixels the fish is in). Simultaneously, a depth image from AR is saved.
2. The picture is then sent to two AI models:
   a. The picture is classified so that we know what species of fish has been caught.
   b. The picture is segmented. All pixels that contain fish are set to value 1, remaining to value 0.
3. The segmented picture is then sent to a proprietary ‘skeleton’ algorithm to find a centre line of said fish. All pixels that are on the calculated centre line are saved.
4. Now that we have the calculated centre line of the fish, we map these pixels to “Real World” coordinates (x, y, z). Ar points (x, y, z) are then placed along the calculated centre line of the fish. Finally, we add up (integrate) all the points along the curve and get an estimate of the length of the fish.
5. With said estimated length and species are known. We use empirical length and weight values for said species (k-factor) to give estimates of weight of said fish.

### AI-Fish Classification and Segmentation

TensorFlow Lite is a lightweight and optimised version of the TensorFlow machine learning framework designed to run machine learning models on mobile and embedded devices, as well as other resource-constrained environments. It is a software library that allows developers to deploy machine learning models on mobile devices, including smartphones, tablets and even microcontrollers.

TensorFlow Lite is designed to provide high performance and low latency, allowing it to run efficiently on devices with limited processing power and memory. This is achieved by using techniques such as model quantisation, which reduces the accuracy of the model's weights and biases to allow them to be stored and processed using fewer bits. TensorFlow Lite also supports hardware acceleration on a variety of platforms, including CPUs, GPUs and specialised machine learning hardware such as Google's Edge TPU. In addition to providing a runtime to run machine learning models on devices, TensorFlow Lite also includes tools to convert models trained with the full TensorFlow framework into a format that can be used with TensorFlow Lite. This allows developers to easily deploy models trained with TensorFlow on mobile and embedded devices.

Overall, TensorFlow Lite makes it easier for developers to bring machine learning functionality to mobile and embedded devices, allowing them to build intelligent applications that run locally on the device, without the need for network connectivity or cloud-based processing.

### AR “Real World position”

ARCore is a software development kit (SDK) developed by Google that provides developers with tools to build augmented reality (AR) experiences on Android devices. ARCore uses the camera and sensors on the device to understand and interact with the physical world, allowing users to place virtual objects and information on top of the real environment. ARCore also supports features such as motion tracking, environment recognition and light detection to provide a more realistic and engaging AR experience.

ARKit is a similar SDK developed by Apple to build augmented reality (AR) experiences on iOS devices.

ARKit also uses the device's camera and sensors to understand and interact with the real-world environment, providing developers with tools to place virtual objects and information on top of it. ARKit also supports features such as motion tracking, environment recognition and light detection, as well as SceneKit and SpriteKit to provide a more advanced AR experience. Both ARCore and ARKit have helped to make augmented reality more accessible and user-friendly for developers and users on mobile devices.

### Skeleton

Topological skeleton, also known as topological reduction, is a technique used in image processing and computer vision to simplify and represent an object as a series of lines or curves.

Topological skeleton consists of a thin and robust representation of a shape, maintaining its geometric shape and structure but eliminating unnecessary details.

Topological skeleton can be computed using algorithms that iteratively thin out an image or shape by removing pixels or voxels that are not part of the skeleton. This results in a representation of the object as a series of points representing the centres of the original shapes or lines.

Topological skeleton can be used in a variety of image processing and computer vision applications, such as analysing biological tissue, recognising objects and patterns, and segmenting images and patterns, and segmenting images. It can also be useful for reducing the amount of data required to represent an object, which can be beneficial in applications with limited storage capacity or processing power.

### The Result

Overall, this approach combines the power of Al and computer vision with the user-friendly interface of AR to provide a convenient and accurate way to measure fish length in the field.

Below you can see the segmentation and skeleton algorithms.
Skeleton #1
:Zhang's method (A fast parallel algorithm for thinning digital patterns, T. Y. Zhang and C. Y. Suen, Communications of the ACM, March 1984, Volume 27, Number 3).
Skeleton #2
:Lee's method (T.-C. Lee, R. L. Kashyap and C.-N. Chu, Building skeleton models via 3-D medial surface/axis thinning algorithms. Computer Vision, Graphics, and Image Processing, 56(6):462-478, 1994).
Custom Skeleton #1: Inhouse development (Fiskher)

1. A method for estimating a weight of a fish, said method comprising the steps of;
take a picture of said fish using a camera,
send said picture to at least one AI model, wherein said picture is classified with regard to what species of fish has been caught,
segment said picture by setting all pixels containing fish to a first value and remaining pixels are set to a second value,
send said segmented picture to an algorithm to find a centre line of said fish, and save all pixels that are on a calculated centre line,
map said pixels on said calculated centre line to “Real World” coordinates (x, y, z),
augmented reality (AR) points (x, y, z) are then placed along said calculated centre line of the fish
add up (integrate) all points along said calculated centre line and estimate a length of said fish
use empirical length and weight values for said species to estimate said weight of said fish based on said estimated length and species of said fish.

2. Method according to claim 1, wherein said camera is connected to a mobile device such as a mobile phone or tablet.

3. Method according to claim 1, wherein said empirical length and weight values are k-factor.
